(19) United States
(12) Patent Application Publication
(10) Pub. No.: US 2011/0243652 A1
(43) Pub. Date: Oct. 6, 2011

(54) Fitting for a Glass Door

(75) Inventors: Oliver Walhorn, Werther (DE); Thomas Vogler, Bad Salzuflen (DE)

(73) Assignee: DORMA GMBH + CO. KG, Ennepetal (DE)

(21) Appl. No.: 13/132,357

(22) PCT Filed: Nov. 24, 2009
(86) PCT No.: PCT/EP2009/008355

§ 371 Date: Jun. 2, 2011

(30) Foreign Application Priority Data
Dec. 2, 2008 (DE) 10 2008 059 927.1
Feb. 11, 2009 (DE) 10 2009 008 400.2
Nov. 10, 2009 (DE) 10 2009 052 417.7

(51) Int. Cl. E05D 5/02

(52) U.S. Cl. 403/270

(57) ABSTRACT

A fitting for rotatably or displaceably supporting swing leaf doors or sliding doors made of glass, including an adhesive adapter to be glued onto the door leaf. The adhesive adapter is fastened to a hinge strap or to an adapter support by a fastener. The adhesive adapter is made of glass-fiber-reinforced plastic material.

### PRIORITY CLAIM

This is a U.S. national stage of Application No. PCT/EP2009/008355, filed on Nov. 24, 2009, which claims priority to German Application Nos: 10 2008 059 927.1, filed: Dec. 2, 2008, 10 2009 008 400.2, filed Feb. 11, 2009, and 10 2009 052 417.7, filed Nov. 10, 2009, the contents of which are incorporated herein by reference.

### BACKGROUND OF THE INVENTION

1. Field of the Invention

The present invention relates to a fitting for rotatably or displaceably supporting swing leaf doors or sliding doors made of glass, comprising an adhesive adapter to be glued onto the door leaf, wherein the adhesive adapter is fastened to a hinge strap or to an adapter support by a fastener.

2. Related Art

Fittings for swing leaf doors or sliding doors made of glass are generally connected to the door by clamping the glass pane or by a bore in the glass. When clamping the glass pane, as it is often used with roller carriages for sliding doors, the fitting is always located in the border area of the glass pane, because inevitably both sides of the glass pane are subject to pressure. The required clamping pressure is generated via an interlocking device, which is disposed above the glass edge, respectively the front edge of the glass pane. This is why this clamping attachment height-wise can not be construed as compact as it would be necessary for an appealing design. In this case, the height of the clamping attachment has an adverse effect on the height of the roller rail, which again does not result in an appealing design.

When attaching the fitting to the glass pane by a bore or a cut-out, in which the half-fittings are connected via a fastening element, which passes through the glass pane, there is always the risk of breaking the glass. Other disadvantages are the manufacturing costs and the relatively expensive procedure, whereby replacing or adapting the glass pane on the construction site is almost impossible.

In order to avoid such problems, fittings are known that are bonded to the glass pane. When frontally bonding the fitting, a front edge having a certain length or certain surface needs to be available, in order to achieve reliable bonding. Therefore, it is hardly possible to realize a fitting with a filigree appearance.

DE 20104851 U1 describes a bonded fitting, which is glued to the surface of the glass pane and thereby partially covers simultaneously two front edges. Based on the disposition of the fitting in the corners of a swing leaf door, the fittings have a very limited application range and thus restricted design options.

DE 10002679 A1 describes a fitting made of a metallic material exclusively glued to the glass surface. An upper fitting part, to which the second hinge strap is disposed via a bearing eye, engages in the lower fitting part glued to the glass pane. This hinge eye, visible to the user, is not compact enough in this case to comply with modern design requirements.

Another problem with bonded fittings represents the necessary safety for the user of the glass door. Failure of a bonded fitting leads in many cases to the glass door breaking, whereby the user might incur serious injury. This risk of injury is particularly high with shower doors made of glass. In this case, after the glassbreak, it is very often impossible to find the cause of the failure of the bonding spot.

### SUMMARY OF THE INVENTION

It is an object of one embodiment of the invention to provide a bondable fitting, which is easy and inexpensive to manufacture and allows for reproducible bonding.

One embodiment of the invention is characterized in that the adhesive adapter is made of a glass-fiber-reinforced plastic material. As the glass fibers, when injection-molding the plastic material, protrude in a random arrangement from the adhesive adapter, principally glass is bonded to glass, which is an optimal mating of materials for this connecting technique.

In another variant, the problem is solved in that a metallic adhesive adapter with a metallic bonding surface is provided with a coating of plastic material.

A preferred embodiment is achieved if the glass-fiber-reinforced plastic material consists of polyamide, wherein the glass-fiber portion is to the amount of 50% to 70%, preferably of 60%. In this case, the plastic material serves as the support material for the glass-fibers. The above described glass-fiber portion provides the adapter with sufficient stability in order to carry a door via a hinge strap or via an adapter support.

A reproducible adhesive bond is achieved in that the adhesive adapter has a bonding surface and a counter-surface, wherein at least one web is disposed on the bonding surface, by which web a thickness of the adhesive layer is determined.

In this case, the webs may be configured as neps, stripes or rings, which are very easily and inexpensively manufactured.

A stable fitting that is able to bear a load is realized in that an insert with a thread is incorporated into the adhesive adapter, wherein the thread is accessible from the counter-surface. The insert is directly embedded into the adhesive adapter during the injection-molding operation and allows for a long life span without the thread experiencing any wear and tear.

Another improvement is achieved in that the thread of the insert is configured as a through-hole thread, the core removing hole thereof continuing in the adhesive adapter. When screwing the fastener in, it cuts a thread into the core removing hole, whereby an inexpensive and integral self-locking system is created.

Another measure enhancing the stability is achieved in that the insert has an undercut, which effects anchoring in the plastic material of the adhesive adapter.

As the counter-surface is chamfered towards the border of the adhesive adapter, a demoulding diagonal is created at the same time for the manufacturing process of the adhesive adapter during injection-molding of plastic material.

In a preferred embodiment, the adhesive adapter has a transponder, which serves for identifying the fitting and records all manufacturing parameters. It is thereby possible to reliably distinguish a genuine fitting from a counterfeit fitting.

The transponder is incorporated into the adhesive adapter by a capsule, wherein the capsule protects the electronic components during the manufacturing operation. The transponder together with the capsule is embedded into the adhesive adapter during the manufacturing operation, such as to allow for an inexpensive manufacturing.

Fastening the adhesive adapter to the door leaf is realized by means of a UV-hardening and light-hardening acrylate adhesive. This adhesive is permanently resistant to aging.

In order to compensate for tolerances, adjusters for adjustability are disposed between the adhesive adapter and the hinge strap or the adapter support. These adjusters may allow for vertical and/or horizontal and/or axial adjustability.

### BRIEF DESCRIPTION OF DRAWINGS

Hereinafter, further measures enhancing the invention will be illustrated in detail in conjunction with the description of one preferred embodiment of the invention based on the Figures, in which:

FIG. 1: is a perspective illustration of a pivot fitting with an adhesive adapter;

FIG. 2: is a lateral sectional illustration through the adhesive adapter;

FIG. 3: is a perspective illustration of the bonding surface of the adhesive adapter;

FIG. 4: is a perspective illustration of the fastening side of the adhesive adapter;

FIG. 5: is another variant of an adhesive adapter;

FIG. 6: is another variant of a metallic adhesive adapter;

FIG. 7: is a roller carriage for a sliding door to be connected to the adhesive adapter; and

FIG. 8: is the roller carriage with the adhesive adapter glued to a sliding door.

### DEATAILED DESCRIPTION OF DRAWINGS

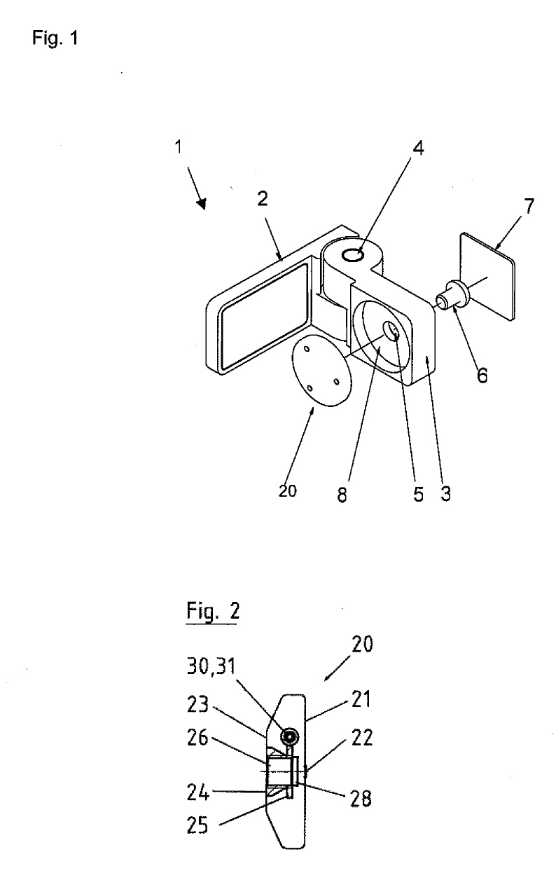

In FIG. 1, a fitting 1 with a first hinge strap 2 and a second hinge strap 3 is illustrated, which are rotatably connected to each other via a pivot 4. In this embodiment, the first hinge strap 2 is configured as an attachment to a wall or to a casing. The second hinge strap 3 has a depression 8 for accommodating an adhesive adapter 20. In this embodiment, the adhesive adapter 20 is configured as a circular or round disc. Furthermore, the second hinge strap 3 has a bore 5, through which a fastening element 6 can pass and be screwed to the adhesive adapter 20. The fastening element 6 may then be closed by a cover cap 7. The depression 8 and the bore 5 are dimensioned with regard to the diameter of the fastening element 6 and of the adhesive adapter 20 such that adjustability of the fitting 1 in relation to the adhesive adapter 20 is possible in vertical and/or horizontal direction. In order to achieve tolerance compensation in the direction of the glass door, namely in axial direction to the fastening element 6, non-illustrated spacer rings may be inserted between the adhesive adapter 20 and the second hinge strap 3.

The lateral sectional illustration through the adhesive adapter 20 in FIG. 2 shows a bonding surface 21, which may have one or more webs 22. The webs 22, configured as neps, as stripes, or as a ring, may be disposed on the bonding surface 21. The height of the webs 22 corresponds to the thickness of the adhesive layer. Reproducibility is thereby provided in terms of amount and thickness of the adhesive layer, because this influences the other parameters for hardening the adhesive. An insert 24 with a thread 26 is incorporated into the counter-surface 23. As the adhesive adapter 20 consists of plastic material, the insert 24 has an undercut 25 which provides a better embedding in the adhesive adapter 20. It is obvious that the thread 26 corresponds to the fastening element 6. Furthermore, a capsule 30 with a transponder 31 is incorporated into the adhesive adapter 20. The capsule 30 is concealed in the plastic material mixture during the manufacturing process of the adhesive adapter 20. The counter-surface 23 is chamfered towards the border of the adhesive adapter 20, whereby simultaneously a demoulding diagonal is provided for the manufacturing process.

The thread 26 may be configured as a through-hole thread. The core removing bore 28 of the thread 26 continues in the adhesive adapter 20. When initially screwing the fastening elements 6 and 13 in, the thread of the fastening elements 6 and 13 passes through the thread 26 of the insert and, with the first turns of the thread, cuts a thread into the core removing hole 28. An inexpensive and integral self-locking for the fastening elements 6 and 13 is thereby created.

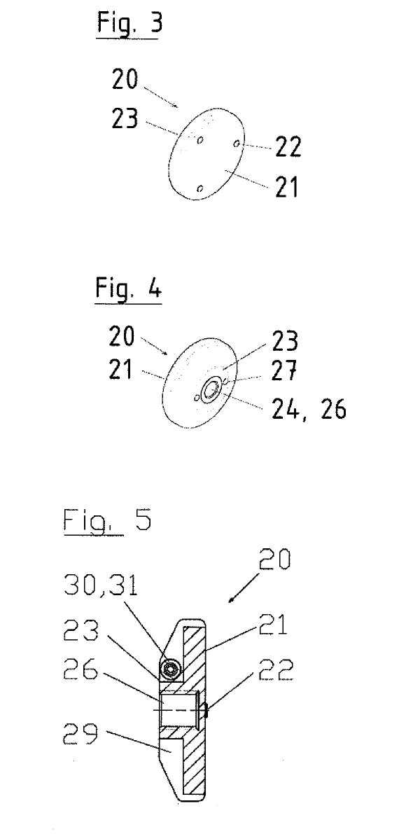

FIG. 3 illustrates the bonding surface 21 with the webs 22. In this embodiment, three webs 22 are uniformly disposed on the bonding surface 21. The webs 22 are point-shaped or configured as neps.

FIG. 4 shows the counter-surface 23 of the adhesive adapter 20. Two bores 27 are machined into the area of the insert 24, respectively of the thread 26, into which bores the pins of a fitting member or of a hinge strap 3 can engage as an anti-rotation device.

The adhesive adapter 20 consists in this embodiment of plastic material reinforced by glass fibers. Usually the mating of the materials glass and plastic allows only for inadequate bonding. A glass-fiber-reinforced polyamide is used as the plastic material, which consists of 50% to 70%, preferably of 60% glass fibers. During the injection-molding of the plastic material into the tool and during subsequent hardening, the glass fiber ends protrude in a random arrangement from the adhesive adapter 20. This results in the effect that in principle glass is bonded to glass, which is a perfect mating of materials for this connecting method. In this case, the plastic material just serves as support material. The diagonal of the counter-surface 23, disposed towards the border of the adhesive adapter 20 serves at the same time as demoulding diagonal for the injection-molding process by which the adhesive adapter 20 is manufactured. The capsule 30 together with the transponder 31 is simultaneously inserted into the adhesive adapter 20 during the manufacturing process.

Bonding between the bonding surface 21 and the glass surface is realized by a colorless UV-hardening and light-hardening acrylate adhesive, which as a solvent-free one component adhesive has the required resistance to aging. In this case, the bonding takes place exclusively on the door leaf without utilizing a front edge of the door.

In order to prove reproducibility of the adhesive layer, in addition to the thickness of the adhesive layer, other manufacturing parameters, such as humidity, temperature of the glass, setting time and setting temperature need to be documented. This documentation is stored in the transponder 31 which is incorporated in a capsule 30 in the adhesive adapter 20. During the manufacturing operation of the adhesive bond, this data is computer-controlled and stored in the transponder 31. In this case, each adhesive fitting receives a continuous manufacturing number, which can be retrieved via an internet data base, among others with indication of the manufacturing site and the customer. It is thereby possible to ensure at any time that the present fitting, at which the bonding spot might have failed, is a genuine product such as to ensure warranty claims. The transponder 31 thus serves at the same time as a hidden copy protection, because especially glass fittings are easily to produce as plagiarism or as a counterfeit product. Active or passive transponders based on RFID-technology can be utilized as the transponders 31. On account of the low performance of the RFID-technology, incorporating a transponder 31 into a metallic fitting has its limitations. An adhesive adapter made exclusively of metal would have such a high insulation effect, that it would be very expensive to read the transponder 31. Therefore, a combination of an adhesive adapter 20 made from plastic material and a transponder 31 is optimal, because incorporating the transponder 31 by a capsule 30 during the injection-molding process is easily and inexpensively to realize, while automatic storing of the required parameters is possible during the manufacturing process.

Another embodiment of an adhesive adapter 20 is illustrated in FIG. 5. This adhesive adapter 20 essentially consists, according to the state-of-the-art, of a metallic structural component, the metallic bonding surface 21 thereof being affixed to the door leaf by bonding. A thread 26, which corresponds to the fastening elements 6 and 13, is machined into the adhesive adapter 20. In order to incorporate the transponder 31 into the fitting, the adhesive adapter 20 is provided with a coating 29 of plastic material into which the transponder is concealed by a capsule 30. In this embodiment, the border area of the adhesive adapter 20 and the surface facing away from the door leaf are provided with a coating 29 of plastic material. This adhesive adapter 20 as well can be provided for example with point-shaped webs 22, which ensure a uniform thickness of the adhesive layer. Furthermore, the counter-surface 23 of the adhesive adapter 20 may be provided with a demoulding diagonal which simplifies the manufacturing process.

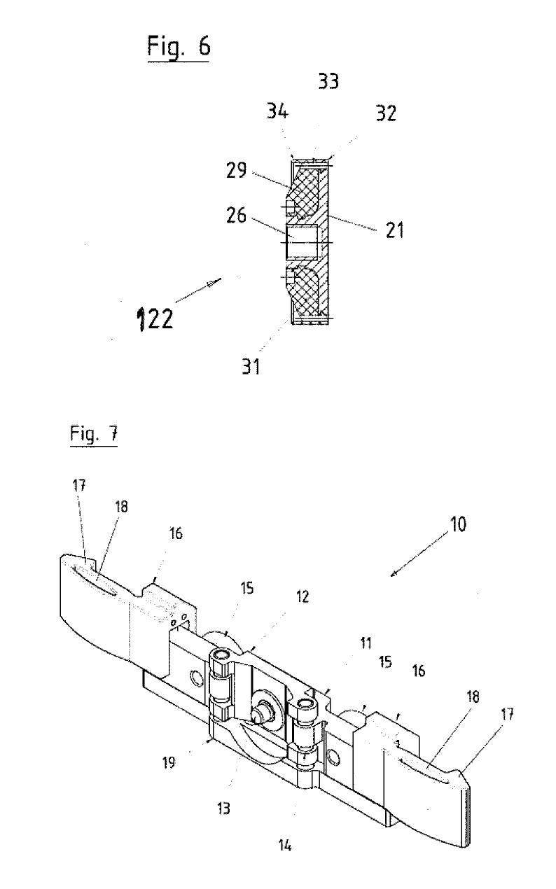

Essential parts of the embodiment in FIG. 6 correspond to the embodiment according to FIG. 5. In this case again, an adhesive adapter 122 is configured with a metallic bonding surface 21 and is embedded into a coating 29 of plastic material. A transponder 31 is incorporated into the coating 29 of plastic material. Towards the bonding surface 21, the coating 29 has a surrounding elevated edge 32, which protrudes beyond the bonding surface 21. The height of the edge 32 may be configured such that—analogously to the webs 22—the thickness of the adhesive layer is determined. As the edge 32 deforms during the bonding operation, when pressing the adhesive adapter 122 onto the door surface, and as the space for the still liquid adhesive layer thus becomes smaller, one or more bores 33 are fitted on the circumference of the coating 29 in spatial vicinity to the edge 32, which should discharge the excess liquid adhesive, respectively excess air from the bonding surface 21. On the rear side of the adhesive adapter 122 in the area of the counter-surface 23, another surrounding edge 34 is disposed at the exterior circumference of the coating 29, which should prevent the discharged adhesive from dripping down the exterior wall of the adhesive adapter 122 and thus prevent it from soiling the surface of the door. Once the bonding operation is completed, in which the edge 32 is deformed and compressed, the latter bears flush against the surface of the door and thus prevents water or cleaning products from penetrating into the bonding surface 21.

FIG. 7 shows an inventive fitting for a sliding door 40, which has a connection to an adhesive adapter 20. The illustrated roller carriage 10 shows a roller support 11, at which two rollers 15 are disposed for the roller rails. Via an adjusting device 14, the roller support 11 is connected to an adapter support 12 such that a vertical adjustability is possible for adjusting the height of the door. A fastening element 13, which engages in the thread 26 of the adhesive adapter 20, is rotatably supported at the adapter support 12. The adapter support 12 is configured in a concave shape in order to receive the adhesive adapter 20 such as to create a reception space for the adhesive adapter 20 by which the least possible construction depth is achieved. Also disposing the adapter support 12 between the rollers 15 ensures that the construction depth of the roller carriage 10 is minimized. In order to receive the rollers 15, the roller support 11 has indentations, respectively a step, which are able to receive at least a portion of the construction depth of the rollers 15. The bottom of the roller carriage 10 is shielded by a screen 19. On one side or on both sides, the roller support 11 may be provided with a lift-off protection 16. In this case, the lift-off protection 16 may be fitted onto the roller support 11 and be attached thereto. In this case, the roller support 11 may be retrofitted with one or two lift-off protections 16. A hook 17, for engaging in a stopper or a limit stop, is disposed at the lift-off protection 16. Furthermore, the lift-off protection 16 has a buffer 18, which dampens potential impacting of the sliding door against a limit stop. In order to achieve tolerance compensation in the direction of the glass door, non-illustrated spacers can be inserted between the adhesive adapter 20 and the adapter support 12.

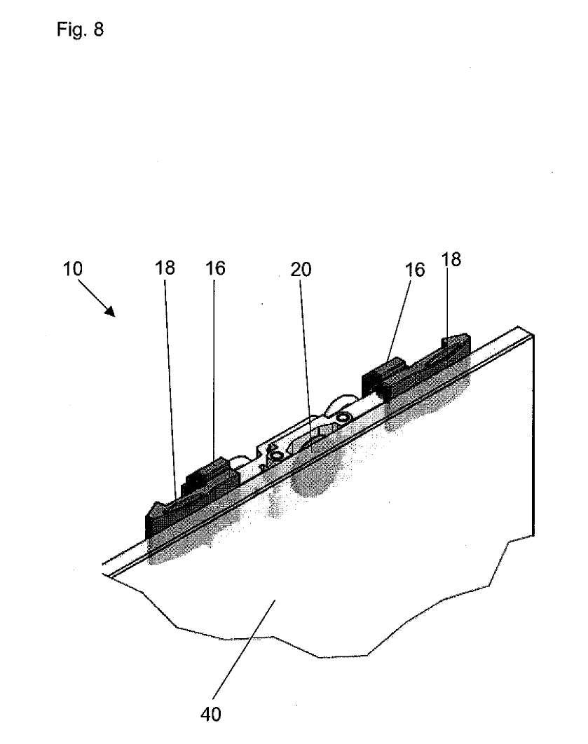

The connection of the roller carriage 10 to a sliding door 40 is illustrated in FIG. 8. In this case, the adhesive adapter 20 is glued to the door leaf. The roller carriage 10 is mounted to the adhesive adapter 20 via the fastening element 13. In this case, the roller carriage 10 is rotatably supported about the fastening element 13 such as to realize compensation towards a roller rail or to compensate a non-uniformly suspended sliding door. In this case, the sliding door 40 may freely pivot about the axis of the fastening element 13. The exterior surfaces of the buffer 18 of the lift-off protection 16 bear resiliently against the sliding door 40 and eliminate the play resulting from the connection of the adhesive adapter 20 with the roller carriage 10.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-16. (canceled)

17. A fitting for one of rotatably and displaceably supporting a door leaf, comprising:
at least one of a hinge strap and an adapter support; and
an adhesive adapter configured to be glued onto the door leaf fastened to one of the hinge strap and the adapter support by a fastener,
wherein the adhesive adapter comprises at least one of a glass-fiber-reinforced plastic material and a metallic element each with a bonding surface that is provided with a coating of plastic material.

18. The fitting according to claim 17, wherein the glass-fiber-reinforced plastic material comprises polyamide, wherein the glass-fiber portion is 50% to 70%.

19. The fitting according to claim 17, wherein the adhesive adapter comprises a bonding surface and a counter-surface opposite the bonding surface, wherein at least one web is disposed on the bonding surface by which a thickness of the adhesive layer is determined.

20. The fitting according to claim 19, wherein the at least one web is configured as one or more of a nep, a stripe, and a ring.

21. The fitting according to claim 19, wherein the adhesive adapter further comprises an insert with a thread that is accessible from the counter-surface.

22. The fitting according to claim 21, wherein the thread is configured as a through-hole thread, a core removing hole thereof continuing in the adhesive adapter.

23. The fitting according to claim 21, wherein the insert has an undercut.

24. The fitting according to claim 19, wherein the counter-surface is chamfered towards the border of the adhesive adapter.

25. The fitting according to claim 17, wherein the adhesive adapter has a transponder that at least identifies the fitting.

26. The fitting according to claim 25, wherein the transponder is incorporated into the adhesive adapter by a capsule.

27. The fitting according to claim 26, wherein the transponder together with the capsule is embedded into the adhesive adapter during a manufacturing operation.

28. The fitting according to claim 17, wherein the adhesive adapter is bonded to the door leaf by a UV-hardening and light-hardening acrylate adhesive.

29. The fitting according to claim 17, wherein, in an area of its exterior circumference, the coating has a surrounding edge that protrudes beyond the bonding surface.

30. The fitting according to claim 29, wherein the coating, in the area toward an exterior circumference, has at least one bore configured to discharge one or more of air and adhesive from the bonding surface.

31. The fitting according to claim 30, wherein, on the rear side of the adhesive adapter in the area of the counter-surface, a surrounding edge is disposed at the exterior circumference of the coating.

32. The fitting according to claim 17, further comprising an adjuster disposed between the adhesive adapter and one of the hinge strap and the adapter support.

33. The fitting according to claim 18, wherein the glass-fiber portion is 60%.
